(19) United States
(12) Patent Application Publication
(10) Pub. No.: US 2007/0232723 A1
(43) Pub. Date: Oct. 4, 2007

(54) Aqueous pigment ink composition, inkjet ink and ink set

(75) Inventor: Jun Arakawa, Ashigarakami-gun (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/727,785

(22) Filed: Mar. 28, 2007

(30) Foreign Application Priority Data
Mar. 29, 2006 (JP) 2006-092306

(51) Int. Cl. C09D 11/00

(52) U.S. Cl. 523/160; 523/161

(57) ABSTRACT

The aqueous pigment ink composition includes: a pigment; and a block polymer containing at least one type of hydrophilic block and at least one type of hydrophobic block, wherein: an average Stokes diameter of dispersed particles including the pigment and the block polymer is in a range of 30 nm to 100 nm; and a total content of metal in the aqueous pigment ink composition is not more than 100 ppm with respect to the pigment.

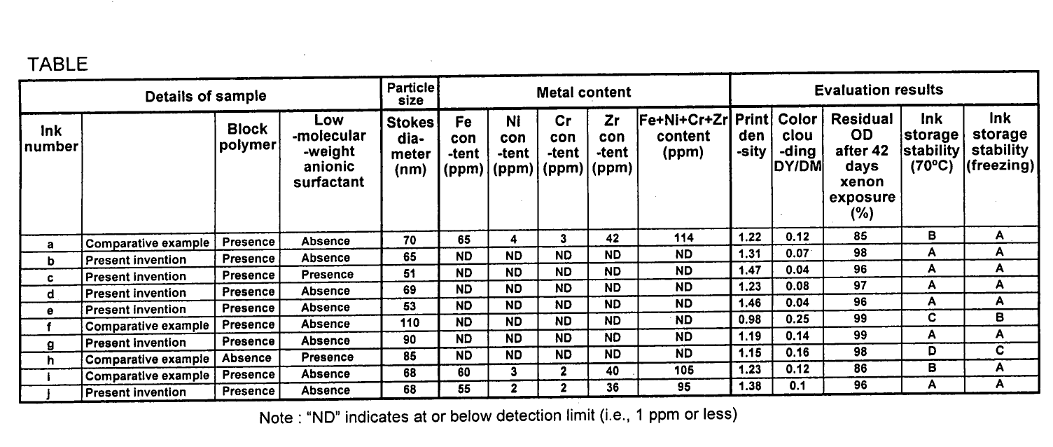

### BACKGROUND OF THE INVENTION

1. Field of the Invention

The present invention relates to an aqueous pigment ink composition including a pigment dispersion for an aqueous pigment ink, and to an inkjet ink and ink set. More particularly, the present invention relates to an aqueous pigment ink composition which provides an inkjet ink that is bright and vivid and has good light-fastness.

2. Description of the Related Art

Inkjet printing is a printing method that has grown rapidly in recent years, and in full-color printing using liquid inks, dyes are the most commonly used coloring material components. However, with expansion of the range of application of inkjet printing, there have been growing demands for the development of quality inks having higher durability, and dye-based inks which rectify the poor light resistance and water resistance of dye inks have been developed. The first inkjet ink using a pigment coloring material was carbon black ink manufactured by DuPont (E.I. du Pont de Nemours & Company (Inc.)) in 1993, and since then various types of color pigments have been investigated and ink sets using pigments only have been developed for practical application.

Apart from the items described above, some characteristics required of an inkjet ink are that it should be bright and produce no color bleeding, no color clouding and no nozzle blockages, that it should not precipitate or increase in viscosity over a long period of time, and the like. As a way of satisfying these characteristics, Japanese Patent Application Publication No. 2005-281691 discloses a method in which an aqueous pigment dispersion containing a block polymer having polyalkenyl ether as the main chain structure is used as an inkjet ink. The dispersion used in the ink is obtained by finely dispersing a pigment and a block polymer having a main chain structure of polyalkenyl ether and having a hydrophobic block segment and a hydrophilic block segment, in water or the like, in such a manner that the particle size is 80 nm or less.

Based on the method described in Japanese Patent Application Publication No. 2005-281691, color bleeding during printing could be suppressed by using a finely dispersed pigment, and the temporal storage characteristics of the liquid were good. However, when this method was actually carried out, it was discovered that the light resistance, which should be satisfactory in principle in the case of a pigment, was in fact unsatisfactory. The light resistance is thought to be determined by the chemical structure and the crystalline structure of the pigment, but in the field of coating materials, it has been known for a long time that the light resistance also changes with the size of the dispersed particles of pigment in cases of an organic pigment. In other words, it has been observed that there is a tendency for the light resistance to become weaker, as the particle size becomes smaller, (see O. Hafner, J. Paint Tech., 47, 609, 1975). It is expected that a similar phenomenon will occur in the case of an aqueous inkjet ink. Furthermore, it has also been discovered that if, conversely, the pigment particles are large in size, then although the light resistance is satisfactory, a decline in the color saturation and color density is observed due to light scattering (A. D. Bermel et. al., J. Imaging Sci. Tech, 43, 320, 1999).

Japanese patent application No. 2001-187851 discloses an inkjet ink containing 30 ppm or less of Fe, Co, Ni, Cr, Si, Al, Ca, Na, K, Zr, and Ti, and these metals in ion form or metal-compound form.

Consequently, there have been demands for technology which is capable of achieving satisfactory color saturation and color density, and obtaining sufficiently strong light resistance, in pigment-based inks containing pigment in a finely dispersed state.

### SUMMARY OF THE INVENTION

The present invention has been contrived in view of the foregoing circumstances, a first object thereof being to provide an aqueous pigment ink composition which yields good lightfastness (light resistance) of the printed image when used as an aqueous inkjet ink. A second object of the present invention is to provide an aqueous pigment ink composition whereby high color saturation and high color density can be achieved in inkjet recording using an aqueous dye-based ink. A third object of the present invention is to provide an aqueous pigment ink composition which makes it possible to manufacture an aqueous pigment-based ink having good storage stability.

Consequently, by applying the aqueous pigment ink composition according to the present invention to an inkjet ink, it is possible to provide a high-quality printed object which has good color saturation, color density and good lightfastness of the color image upon printing. Furthermore, it is also possible to provide an ink which displays extremely little deterioration of the ink during storage in a cartridge.

The present invention is directed to an aqueous pigment ink composition comprising: a pigment; and a block polymer containing at least one type of hydrophilic block and at least one type of hydrophobic block, wherein: an average Stokes diameter of dispersed particles including the pigment and the block polymer is in a range of 30 nm to 100 nm; and a total content of metal in the aqueous pigment ink composition is not more than 100 ppm with respect to the pigment.

In this aspect of the present invention, a block polymer comprising at least one type of hydrophilic block and at least one type of hydrophobic block is included in the aqueous pigment ink composition, and therefore it is possible to ensure high dispersion stability of the pigment and long-term storage stability. Furthermore, the average Stokes diameter of the dispersed particles formed by the pigment and the block polymer is set to the range of 30 nm to 100 nm, and therefore, the aqueous pigment ink composition has good light-fastness at the same time as having satisfactory color saturation and color density. Moreover, the overall content of metal in the aqueous pigment ink composition is set to be equal to or less than 100 ppm with respect to the pigment, and therefore, it is possible to improve the fastness of the pigment in the printed image.

Preferably, the metal includes at least one of Fe, Ni, Cr and Zr.

There are detrimental effects on the fastness of the pigment in the printed image if at least one of the metals is Fe, Ni, Cr or Zr, in particular. Accordingly, the present invention is especially valuable if at least one of the metals is Fe, Ni, Cr or Zr.

Preferably, the average Stokes diameter of the dispersed particles is 40 nm to 80 nm.

In this aspect of the present invention, the average Stokes diameter of the dispersed particles is set to be 40 nm to 80 nm, and therefore it is possible to provide an aqueous pigment ink composition having even better color saturation and color density, and good lightfastness.

Preferably, the total content of the metal is not more than 20 ppm with respect to the pigment.

In this aspect of the present invention, the overall content of metal is set to be equal to or less than 20 ppm with respect to the pigment, and therefore it is possible further to improve the fastness of the pigment in the printed image.

Preferably, the aqueous pigment ink composition further comprises an anionic surfactant.

In this aspect of the present invention, an anionic surfactant is included in the aqueous pigment ink composition, and therefore it is possible to set the pigment to a high density in the aqueous pigment ink composition. Hence, the color density in the printed image is satisfactory.

Preferably, a number average molecular weight of the anionic surfactant is 100 to 2000.

In this aspect of the present invention, the number average molecular weight of the anionic surfactant is 100 to 2000, and therefore the aqueous pigment ink composition is kept at low viscosity and has good ejection stability from an ink head.

Preferably, the block polymer has a polyalkenyl ether structure.

Preferably, the block polymer has a repeated unit of a vinyl ether polymer structure having an oxyethylene side chain as expressed by the following general formula (1):

—(CH₂—CH(OR¹))— (1)

where R¹ is a group represented by —(CH₂—CH₂—O)ₖ—R²,—(CH₂)ₘ—(O)ₙ—R²,—R³—X, —(CH₂—CH₂—O)ₖ—R₃—X, or —CH₂)ₘ—(O)ₙ—X; R² represents a hydrogen atom, a straight-chain or branched alkyl group having 1 to 4 carbon atoms, or —CO—CH═CH₂,—CO—C(CH₃)═CH₂, —CH₂—CH═CH₂, or —CH₂—C(CH₃)═CH₂; R³ represents an aliphatic hydrocarbon group or an aromatic hydrocarbon group; and X represents a group that has anionic properties and is selected from a carboxylic acid group, a sulfonic acid group, and a phosphoric acid group.

By using the block polymers described above, it is possible to ensure that the pigment has good dispersion stability and long-term storage stability.

Preferably, the pigment included in the dispersed particles is dispersed by an ultra high-pressure homogenizer, at a pressure of not less than 150 MPa.

Preferably, the pigment included in the dispersed particles is dispersed by an ultrasonic homogenizer, at a frequency of not more than 25 kHz and an energy density in a dispersion unit of not less than 100 W/cm².

Preferably, the pigment included in the dispersed particles is dispersed by an ultrasonic homogenizer, at a frequency of not more than 25 kHz and an energy density in a dispersion unit of not less than 100 W/cm², and then dispersed by an ultra high-pressure homogenizer, at a pressure of not less than 150 MPa.

Preferably, the pigment included in the dispersed particles is dispersed by an ultra high-pressure homogenizer, at a pressure of not less than 150 MPa, and then dispersed ultrasonically by an ultrasonic homogenizer, at a frequency of not more than 25 kHz and an energy density in a dispersion unit of not less than 100 W/cm².

In these aspects of the present invention, the dispersion is performed under any of these conditions, and therefore it is possible to disperse the dispersed particles very finely without using beads. Hence, the composition is not liable to contain metal and it is possible readily to obtain any one of the aqueous pigment ink compositions described above.

The present invention is also directed to an inkjet ink containing any one of the aqueous pigment ink compositions described above.

In this aspect of the present invention, an ink containing the aqueous pigment ink composition according to the present invention is used in an inkjet system, and therefore it is possible to obtain an ink that is bright and vivid and has good lightfastness.

Preferably, the inkjet ink is for use in a thermal inkjet system.

In this aspect of the present invention, the metal content is suppressed in the inkjet ink described above, and therefore adverse effects on the ejection stability and the fastness of the color image are not liable to occur due to the metal in the ink being heated in the vicinity of the heating bodies of a thermal inkjet apparatus. Hence, such an ink is especially suitable for ink used in a thermal inkjet apparatus.

The present invention is also directed to an inkjet ink set comprising three color inks of cyan ink, magenta ink and yellow ink, wherein at least one color ink of the three color inks is any one of the inkjet inks described above.

By applying the aqueous pigment ink composition according to the present invention to an inkjet ink, it is possible to provide a high-quality printed object which achieves a good balance among good color saturation, color density and light-fastness of the color image upon printing. Furthermore, it is also possible to provide an ink which displays extremely little deterioration of the ink during storage in a cartridge.

### BRIEF DESCRIPTION OF THE DRAWING

The nature of this invention, as well as other objects and advantages thereof, will be explained in the following with reference to the accompanying drawing, which is a table for explaining examples of the present invention.

### DETAILED DESCRIPTION OF THE PREFERRED EMBODIMENTS

Below, aqueous pigment ink compositions according to embodiments of the present invention are described below in detail. The description of the compositional requirements given below is based on typical embodiments of the present invention, but the present invention is not limited to these embodiments. In the present specification, numerical ranges expressed using “to” indicate a range where the numbers before and after the “to” are the inclusive lower limit value and upper limit value, respectively.

The aqueous pigment ink composition according to embodiments of the present invention is an ink composition which contains at least a block polymer compound having polyalkenyl ether as the main chain structure, and a solvent (an aqueous organic solvent), wherein the average Stokes diameter of the particles comprising the block polymer compound and the pigment is in the range of 30 nm to 100 nm, and desirably, in the range of 40 nm to 80 nm. Furthermore, the ink composition according to embodiments of the present invention also includes a composition where the pigment is incorporated in the block polymer compound.

Furthermore, the method of manufacturing an ink composition according to embodiments of the present invention is a method of manufacturing an ink composition containing a block polymer compound, a pigment and a solvent. The method of manufacturing an ink composition includes: a dispersion step of obtaining a dispersed liquid by dispersing a pigment and a block polymer having a main chain structure of polyalkenyl ether comprising at least a hydrophobic block segment and a hydrophilic block segment, in the solvent; and an ink forming step of adding and mixing the aforementioned solvent or another solvent, a surfactant, and the like, to the dispersed liquid.

### Block Polymer

The block polymer compound used in the present embodiment means a polymer compound constituted by two or more different block segments, and in order to incorporate the functional material, it contains one or more types of hydrophobic block segment and one or more types of hydrophilic block segment. In the present invention, a hydrophilic block segment means a block segment that does not readily form a bond with a water molecule, and a hydrophilic block segment means a block segment that readily forms a bond with a water molecule. Using a dispersant of this kind gives the ink good dispersion stability and long-term storage stability, and furthermore, the resulting ink also has good ejection stability, even if used in a method where ink droplets are ejected by applying heat energy to the ink.

Block polymers can be categorized according to the arrangement of the block segments, into block polymers having structures indicated as AB type, ABA type, BAB type, ABC type, and the like. Here, A, B and C indicate particular block segments having a certain restricted length. An especially desirable dispersant in the present invention is one comprising two or three types of block segment and having an AB type, ABA type or ABC type of structure. In particular, a block polymer containing a hydrophobic block and a hydrophilic block and having a balanced block size which causes the contribution of these blocks to the dispersion stability, is especially beneficial in implementing the present invention.

It is also possible to incorporate various types of desired functional groups into the hydrophobic block (the block which bonds with the coloring material), and since this improves the dispersion stability, it enables further strengthening of the specific mutual interaction between the polymer dispersant and the pigment. Details of polymers of this kind are disclosed in U.S. Pat. No. 5,085,698 and No. 5,272,201, and also in European Patent Application No. 0 556 649 A1, issued Aug. 25, 1993. Furthermore, several grafted polymers which are usable in the present invention are disclosed in U.S. Pat. No. 5,231,131.

The amount of the polymer dispersant comprising the polymer described above that is contained in the ink depends on the structure, molecular weight and other properties of the polymer used, and the other components constituting the ink, and therefore, it should be set appropriately in accordance with these factors. For example, a polymer which can be used preferably as a dispersant in the ink according to the present invention is one having an average molecular weight of less than 40,000, desirably, less than 20,000, and more desirably, in the range of 1,000 to 10,000. Although it depends on the content of the pigment that is to be dispersed, desirably, the polymer is used in such a manner that the ratio of the amount of pigment to the amount of dispersant (the amount of pigment: the amount of dispersant) is in the range of 10:30 to 10:0.5, based on mass. When a polymer dispersant of this kind is used, the polymer content in the ink is desirably 0.1 to 15 wt % (percent by mass), and more desirably, 0.1 to 8 wt %, with respect to the total amount of ink. If the content of the polymer dispersant in the ink is greater than this range, then it becomes fairly difficult to maintain the ink viscosity at the level desired in terms of an ink for inkjet recording.

Typical examples of monomers which can be selected as a monomer forming the hydrophobic B block include the following monomers, although the present invention is not limited to these. More specifically, methyl methacrylate (MMA), ethyl methacrylate (EMA), propyl methacrylate, n-butyl methacrylate (BMA or NBMA), hexyl methacrylate, 2-ethyl hexyl methacrylate (EHMA), octyl methacrylate, lauryl methacrylate (LMA), stearyl methacrylate, phenyl methacrylate, hydroxyethyl methacrylate (HEMA), hydroxypropyl methacrylate, 2-ethoxyethyl methacrylate, methacrylonitrile, 2-trimethyl siloxyethyl methacrylate, glycidyl methacrylate (GMA), p-trimethacrylate, sorbyl methacrylate, methyl acrylate, ethyl acrylate, propyl acrylate, butyl acrylate, hexyl acrylate, 2-ethylhexyl acrylate, octyl acrylate, lauryl acrylate, stearyl acrylate, phenyl acrylate, hydroxyethyl acrylate, hydroxypropyl acrylate, acrilonitrile, 2-trimethyl siloxyethyl acrylate, glycidyl acrylate, p-triacrylate and sorbyl acrylate can be selected as a monomer forming the hydrophobic B block, for example. Of these, a particularly desirable B block is a homopolymer and a copolymer manufactured from methyl methacrylate, butyl methacrylate, and 2-ethylhexyl methacrylate, and a copolymer of methyl methacrylate and butyl methacrylate.

Desirably, the hydrophilic block of the block polymer has a repeated unit having a vinyl ether polymer structure including an oxyethylene side chain as represented by general formula (1) below.

—(CH₂—CH(OR¹))— (1)

In the general formula (1) described above, R¹ is a group represented by —(CH₂—CH₂—O)ₖ—R²,—(CH₂)ₘ—(O)ₙ—R²,—R³—X,—(CH₂—CH₂—O)ₖ—R³—X, or —CH₂)ₘ—(O)ₙ—X. In this case, R² represents a hydrogen atom, an straight chain or branched alkyl group having 1 to 4 carbon atoms, or —CO—CH═CH₂, —CO—C(CH₃)═CH₂, or —CH₂—CH═CH₂, —CH₂—C(CH₃)═CH₂. R³ represents an aliphatic hydrocarbon group, such as an alkylene group, an alkenylene group, a cycloalkylene group or a cycloalkenylene group; or an aromatic hydrocarbon group, in which a carbon atom may be substituted with a nitrogen atom, such as a phenylene group, a pyrilidene group, a benzylene group, a tolylene group, a xylylene group, an alkyl phenylene group, a phenylene alkylene group, a biphenylene group, a phenyl-pyridine group, or the like (where a hydrogen atom on the aromatic ring may be substituted with a hydrocarbon group). In these groups, where chemically possible, the hydrogen atoms may be substituted with halogen atoms of fluorine, chlorine, bromine, or the like. X represents a group having anionic properties selected from a carboxylic acid group, a sulfonic acid group and a phosphoric acid group. Desirably, R³ has 1 to 18 carbon atoms. Desirably, k is 1 to 18, m is 1 to 36 and n is 0 or 1.

The following formulas show examples of structure of a monomer (I-a to I-o) forming a repeated unit as described above and a block copolymer (II-a to II-e) comprising the monomer, but the structure of the block copolymer used in the present invention is not limited to these.

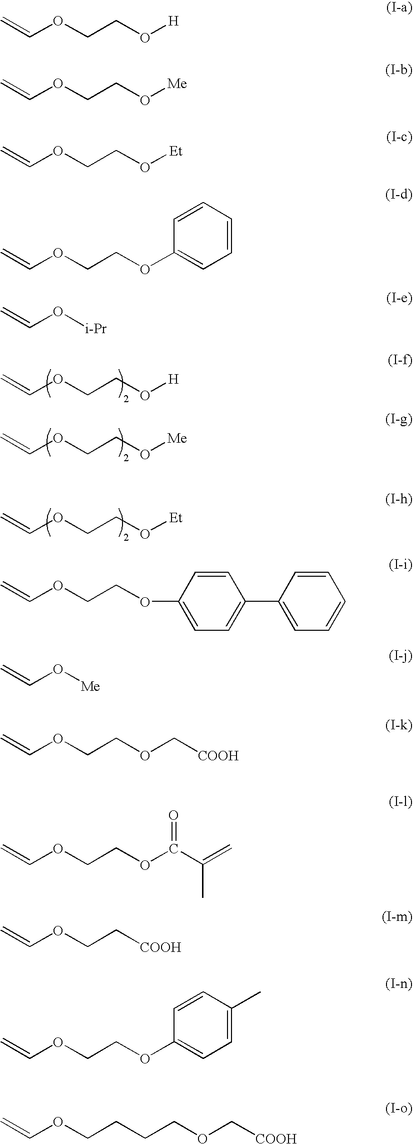

Moreover, desirably, the number of each of repeated units in the block copolymer is 1 to 10,000, independently. Furthermore, the number average molecular weight is desirably 500 to 20,000,000, more desirably, 1,000 to 5,000,000, and most desirably, 2,000 to 2,000,000.

Furthermore, each of the blocks comprising these polyvinyl ethers may be one in which the ether is graft bonded to another polymer, or it may be one in which the vinyl ether monomer is copolymerized with another repeated unit structure.

For the polymer dispersant included in the ink according to the present invention, it is desirable to use a block polymer containing at least one type of monomer unit containing an aromatic ring. Desirable examples of such a monomer unit containing an aromatic ring include: styrene, α-methyl styrene, benzyl acrylate, benzyl methacrylate, and phenyl acrylate. Of these, benzyl methacrylate is particularly desirable. An ink containing a pigment dispersed by a block polymer comprising at least a benzyl methacrylate unit has uniform ink wetting properties with respect to the nozzle end face, and has extremely good ejection durability in an inkjet head.

In the block polymer used as a polymer dispersant, it is especially desirable to use a monomer containing a carboxyl group as the material forming a hydrophilic A block, which has the function of displaying the dispersibility of the pigment in the water. Specific examples of this include: methacrylic acid (MAA), acrylic acid, dimethyl aminoethyl methacrylate (DMAEMA), diethyl aminoethyl methacrylate, t-butyl aminoethyl methacrylate, dimethyl aminoethyl acrylate, diethyl aminoethyl acrylate, dimethylaminopropyl methacrylamide, methacrylamide, acrylamide, and dimethyl acrylamide. Of these, a homopolymer or a copolymer of methacrylic acid or dimethyl aminoethyl methacrylate is desirable.

The function of the C block included in an ABC type block polymer is to impart stability of the dispersion in the presence of the organic component present in the aqueous carrier medium (namely, the water-soluble organic solvent). The organic component contained in the ink is frequently a cause of aggregation of the aqueous pigment dispersion. If the C block of a dispersant comprising an ABC type triblock polymer has good stability in the organic component, then resistance to aggregation can be improved markedly. The monomer forming the C block, which is the constituent element of the C block, depends on the characteristics of the organic component contained in the ink, and it may be hydrophilic or hydrophobic. Furthermore, it may include the monomers given earlier as examples of the constituent element of the B block. More specifically, it may be n-butoxyethyl methacrylate, butyl methacrylate, ethoxy triethylene glycol methacrylate, or the like.

As a basic substance used in order to make the block polymer used as the polymer dispersant soluble in water, it is possible to use, for example, an alkanol amide, such as monoethanol amine, diethanol amine, triethanol amine, ethyl monoethanol amine, ethyl diethanol amine, monoisopropanol amine, disisopropanol amine, or triisopropanol amine; an organic amine, such as ammonia; or an inorganic base, such as potassium hydroxide, sodium hydroxide, lithium hydroxide, or the like.

The optimal base which can be used in the ink according to the present invention differs according to the type of pigment and dispersant selected, but desirably, it is non-volatile and stable, and has good water retention properties. Furthermore, basically, the amount of the basic substance used is found on the basis of the amount calculated from the acid value of the polymer dispersant and amount of base required in order to neutralize that amount. Depending on the circumstances, there may be cases where the amount of base used is greater than the equivalent amount of acid. This is in order to improve dispersibility, adjust the pH of the ink, adjust the recording properties, improve the moisture retention properties, and the like.

The method disclosed in the specification of U.S. Pat. No. 4,508,880 may be used as the polymerization method for the block polymer which can be used preferably as a dispersant in the ink according to the present invention. An AB type of block polymer can be manufactured by using a common anionic polymerization technique. In this, a first block of the copolymer is formed, and when this first block has been completed, a flow of the second monomer is started and the next polymer block is generated. In many of these techniques, and especially in group transfer polymerization methods, the initiator may be a non-functional material, and it may include an acid group (directly, or an acid group used in a blocked form), or it may include an amino group. Firstly, either the hydrophobic B block or the hydrophilic A block is generated. Moreover, an ABA type of block polymer can be manufactured by means of an anionic polymerization or group transfer polymerization technique in which, firstly, one A block is polymerized, whereupon a hydrophobic B block is polymerized, and then a second A block is polymerized.

A polymer having an alkenyl ether structure along with each of the A, B and C block segments is also suitable for use as the block polymer according to the present invention. A block polymer containing a polyalkenyl ether structure can be synthesized by means of a living polymerization method. A synthesis method for a polymer containing a polyvinyl ether structure has been reported in Japanese Patent Application Publication No. 11-080221, and a typical method is that described by Aoshima, et al. (Polymer Bulletin, 15, 417 to 423 (1986); Japanese Patent Application Publication No. 11-322942). By synthesizing a polymer compound by means of the method described by Aoshima, et al., it is possible to synthesize various types of polymers, such as a homopolymer, a copolymer comprising two or more constituent monomers, a block polymer or a grafted polymer, in such a manner that the lengths (molecular weights) are accurately harmonized.

Desirably, the ink relating to the present invention is manufactured by firstly preparing a pigment dispersion liquid obtained by using a polymer dispersant obtained as described above to impart dispersive properties to a pigment, and then mixing and dispersing same in water, or desirably, an aqueous mixed solvent comprising water and a water-soluble organic solvent, thereby adjusting to a suitable pigment density.

### Pigment

The pigment contained in the aqueous pigment ink composition according to the present embodiment is desirably an organic color pigment. Specific examples of organic pigments which can be used in the composition are listed below. Furthermore, it is desirable to use the three basic color pigments of cyan, magenta and yellow, as pigments in the ink composition. It is also possible to use color pigments apart from those described above, light color pigments, pigments having an absorption spectrum in the infrared waveband or ultraviolet waveband, or the like. Furthermore, in the present invention, it is possible to use commercially available pigments, or to use newly synthesized pigments.

Examples of a cyan colored pigment include: C. I. Pigment Blue-1, C. I. Pigment Blue-2, C. I. Pigment Blue-3, C. I. Pigment Blue-15, C. I. Pigment Blue-15:2, C. I. Pigment Blue-15:3, C. I. Pigment Blue-15:4, C. I. Pigment Blue-16, C. I. Pigment Blue-22, and the like; however, the pigment is not limited to these.

Examples of a magenta colored pigment include: C. I. Pigment Red-5, C. I. Pigment Red-7, C. I. Pigment Red-12, C. I. Pigment Red-48, C. I. Pigment Red-48:1, C. I. Pigment Red-57, C. I. Pigment Red-112, C. I. Pigment Red-122, C. I. Pigment Red-123, C. I. Pigment Red-146, C. I. Pigment Red-168, C. I. Pigment Red-184, C. I. Pigment Red-202, C. I. Pigment Red-207, and the like; however, the pigment is not limited to these.

Examples of a yellow pigment include: C. I. Pigment Yellow-12, C. I. Pigment Yellow-13, C. I. Pigment Yellow-14, C. I. Pigment Yellow-16, C. I. Pigment Yellow-17, C. I. Pigment Yellow-74, C. I. Pigment Yellow-83, C. I. Pigment Yellow-93, C. I. Pigment Yellow-95, C. I. Pigment Yellow-97, C. I. Pigment Yellow-98, C. I. Pigment Yellow-114, C. I. Pigment Yellow-128, C. I. Pigment Yellow-129, C. I. Pigment Yellow-151, C. I. Pigment Yellow-154, and the like; however, the pigment is not limited to these.

Furthermore, the added content of the organic pigment is desirably, 1 to 25 wt %, more desirably, 2 to 20 wt %, even more desirably, 5 to 20 wt %, and particularly desirably, 5 to 15 wt %, with respect to the ink.

The organic color pigment of the present embodiment is finely dispersed by a dispersion device as described below, the average Stokes diameter of the dispersed particles after dispersion is in the range of 30 nm to 100 nm, and in particular, it is desirable that it should be in a range between 40 nm and 80 nm.

### Low-Molecular-Weight Anionic Surfactant

The low-molecular-weight anionic surfactant used in the present embodiment is added with the object of causing the organic pigment to disperse stably in the aqueous solvent, while keeping the viscosity of the ink low. The low-molecular-weight anionic surfactant used in the present embodiment is a surfactant having a molecular weight of 2000 or less. Furthermore, the molecular weight of the surfactant is desirably 100 to 2000, and more desirably, 200 to 2000.

In the present embodiment, the low-molecular-weight surfactant has a structure which comprises a hydrophilic group and a hydrophobic group. Furthermore, one or more hydrophilic group and one or more hydrophobic group should be contained independently in one molecule, and furthermore, hydrophilic groups and hydrophobic groups of a plurality of different types may be contained. Furthermore, as appropriate, it is also possible to have a linking group in order to link the hydrophilic group and the hydrophobic group.

The anionic group may be any group having a negative electric charge, but desirably, it is a phosphoric acid group, a phosphonic acid group, a phosphinic acid group, a sulfuric acid group, a sulfonic acid group, a sulfinic acid group or a carboxylic acid group, and more desirably, it is a phosphoric acid group or a carboxylic acid group, and even more desirably, it is a carboxylic acid group.

For the hydrophilic group, apart from an anionic group, it is also possible to include a non-ionic group. The non-ionic group may be polyethylene oxide, or polyglycerine, or a portion of a sugar unit, or the like.

The hydrophobic group has a structure of a hydrocarbon type, a fluorocarbon type or a silicone type, for example, and a hydrocarbon type is especially desirable. Furthermore, these hydrophobic groups may have either a straight chain structure or a branched structure. Moreover, the hydrophobic group may be one straight chain structure or a greater number of straight chain structures, and if it is two or more straight chain structures, then it may comprise a plurality of different types of hydrophobic group. Furthermore, the hydrophobic group is desirably a hydrocarbon group having 2 to 24 carbon atoms, more desirably, a hydrocarbon group having 4 to 24 carbon atoms, and even more desirably, a hydrocarbon group having 6 to 20 carbon atoms.

Furthermore, with regard to the added amount of low-molecular-weight anionic surfactant, a desirable range is one where the pigment can be dispersed uniformly in the aqueous solvent and the ink can be ejected stably; therefore the weight ratio B/C between the weight B of the surfactant and the weight C of the organic pigment is desirably in the range of 0.0001 to 1, more desirably, 0.0001 to 0.5 and even more desirably, 0.0001 to 0.2. Moreover, the ink viscosity is desirably in the range of 1 to 30 mPa·s, more desirably, in the range of 1 to 20 mPa·s, even more desirably, in the range of 2 to 15 mPa·s, and particularly desirably, in the range of 2 to 10 mPa·s.

### Water-Soluble Organic Solvent

The water-soluble organic solvent used in the present embodiment is used with the object of preventing drying and promoting wetting, and the like. Furthermore, preferably, an anti-drying agent is used at the ink spray ports of the nozzles in an inkjet recording system, and it prevents blockages caused by drying of the inkjet ink.

Desirably, the anti-drying agent is a water-soluble organic solvent having a lower vapor pressure than water. More specific examples of the anti-drying agent include: polyhydric alcohols, as typified ethylene glycol, propylene glycol, diethylene glycol, polyethylene glycol, thiodiglycol, dithiodiglycol, 2-methyl-1,3-propanediol, 1,2,6-hexanetriol, an acetylene glycol derivative, glycerine, trimethylol propane, and the like; low alkyl ethers of polyhydric alcohols, such as ethylene glycol monomethyl (or ethyl) ether, diethylene glycol monomethyl (or ethyl) ether, triethylene glycol monoethyl (or butyl) ether, and the like; a heterocyclic compound, such as 2-pyrolidone, N-methyl-2-pyrrolidone, 1,3-dimethyl-2-imidazolidinone, N-ethyl morpholine, or the like; a sulfur-containing compound, such as sulfolane, dimethyl sulfoxide, 3-sulfolene, or the like; a polyfunctional compound, such as diacetone alcohol, diethanol amine, or the like; and a urea derivative. Of these, desirably, the anti-drying agent is a polyhydric alcohol, such as glycerine or diethylene glycol. Furthermore, the anti-drying agents described above may be used independently, or two or more types of anti-drying agent may be used together in combination. Desirably, the content of these anti-drying agents in the ink is 10 to 50 wt %.

Furthermore, preferably, a permeation promoter is used in order to make the ink permeate more readily into the recording medium (printing paper). Specific examples of a permeation promoter which can be used preferably in the present invention include: an alcohol, such as ethanol, isopropanol, butanol, di(tri)ethyelene glycol monobutyl ether, 1,2-hexanediol, or the like; a sodium lauryl sulfate; a sodium oleate; a non-ionic surface active agent; and the like. These permeation promoters display sufficient effects when contained at a rate of 5 to 30 wt % in the ink composition. Moreover, the permeation promoter is desirably used within an added volume range which does not produce bleeding during printing, or print through.

### Other Additives

Well-known additives can be used as other additives used in the present embodiment, and for example, an anti-fading agent, an emulsion stabilizer, an ultraviolet absorber, a preservative, an antibacterial agent, a pH adjuster, a surface tension adjuster, an antifoaming agent, a viscosity adjuster, a dispersant, a dispersion stabilizer, an anti-rusting agent, a chelating agent, or the like can be used. In the case of an aqueous ink, these various additives are added directly to the ink.

Furthermore, in the present embodiment, it is possible to add polymers other than the block polymer of the present invention, in order to improve the fixing properties of the ink to the recording medium, and the friction-resistance properties on the coated surface. Desirably, the aforementioned polymer is dispersed in the form of fine particles, in water or a water-miscible solvent.

### Pigment Dispersion Apparatus

Not only in a method of manufacturing an inkjet ink, but also in a method of manufacturing a general ink, the pigment dispersion step is an extremely important step, and it is possible to display the characteristics of the pigment by dispersing the pigment which is in a secondary aggregation state, so that it forms primary particles. The pigment particle size has a significant effect on transparency, luster and coloring capacity (printing density) and the like, and it is known that the luster, transparency and the vividness of the color are greatly improved if the particles are finer in size. The dispersion apparatus used in this dispersion step is selected in accordance with the required production quality, the viscosity of the product, and the like. The selection of the dispersion apparatus has a significant effect on print quality and production efficiency. As a dispersion apparatus for dispersing the pigment used in the aqueous pigment ink composition according to the present embodiment, in a dispersion medium, it is common to use a kneading machine such as a kneader or roll mill, or a media-based dispersion machine, such as a ball mill, a sand mill or a beads mill. The former type of machine is most commonly used for high-viscosity paints and printing inks, and the like, whereas in the case of a pigment dispersion for a low-viscosity ink, such as normal inkjet ink, it is most common to use the latter option, namely, a media-based dispersion machine.

In recent years, there have been increasing demands for reduced particle size in dispersed pigment particles, and therefore many improvements have been made in media-based dispersion machines. The main area of these improvements has been reducing the bead size. In the past, ball mills or sand mills using natural sand have been employed, but in place of this, it is now more common to use very small ceramic beads having a diameter of 0.5 mm or less. In order to disperse the pigment until the dispersed particle size of the pigment reaches very fine sizes in the region of 300 nm or below, it is necessary to increase the number of bead impacts, without significantly reducing the intensity of the bead impacts. For this purpose, it is beneficial to use very small beads which have a high specific gravity. The material of the very small beads having high specific gravity may be glass, titania, zircon, zirconia, alumina, or the like, and it is common to use beads having zirconia as a main component because of their high specific gravity and low friction.

Other important factors for achieving very fine pigment particles by means of a beads-based dispersion apparatus include the beads filling rate and the agitation speed. If the beads filling rate is increased, then the frequency at which the beads impact against the pigment particles is raised, and hence dispersion proceeds more quickly. Furthermore, if the agitation speed is raised, then both the impact frequency and the kinetic energy of the impacts, are increased. In an embodiment of the present invention, in order to achieve very fine particles of pigment, having an average Stokes diameter in the range of 30 nm to 100 nm, it is necessary to use ceramic beads having a diameter of 0.5 mm or less, and desirably a diameter of 0.3 mm or less, and especially desirably, zirconia beads having a diameter of 0.1 mm or less and a high specific weight (6.0). Moreover, it is also necessary to raise the beads filling rate and the churning speed, and to dedicate a long time to the dispersion process. If these approaches are used, then there is a possibility that metal ions and metallic compounds can be generated from the materials of the inner walls of the dispersion chamber, the agitating blades of the dispersion apparatus, the beads, and the like because of the friction thereof, and the metallic material thus generated can enter into the ink.

It has been pointed out hitherto that metallic ions and metallic compounds cause the components in the ink to aggregate and thus have an effect on the storage stability of the ink and head blockages. The present inventor also has discovered that particular metals affect the fastness of the printed image. More specifically, he has discovered that, especially in cases where a block polymer having polyalkenyl ether as the main chain structure is included in an aqueous pigment ink manufactured by using a pigment dispersion that has been dispersed by a beads mill dispersion apparatus, then the fastness of the printed image is greatly deteriorated due to the inclusion of Fe, Ni, Cr or Zr.

Furthermore, the present inventor also has discovered that in an aqueous pigment ink composition, the fastness of the printed image can be improved by setting the overall content of metal to 100 ppm or less with respect to the pigment.

In order that the overall content of metal is 100 ppm or less with respect to the pigment, it was necessary to carry out investigation into a dispersion apparatus which can achieve a very fine size of the pigment particles, in an average Stokes diameter range of 30 nm to 100 nm, without using beads.

Desirably, the organic pigment according to the present invention is subjected to preparatory mixing before carrying out the dispersion described above. This preparatory mixing involves mixing the starting materials, such as an organic pigment, a block polymer, an aqueous solvent and, if required, a low-molecular-weight anionic surfactant, and a portion of the other materials contained in the ink, and the like, at a weak shearing force by using a mixing device. By carrying out preparatory mixing, the surface of the pigment is wetted with the solvent, thus facilitating the subsequent formation of the dispersion and making it possible to prevent sudden increases in the viscosity in the dispersion or the occurrence of large coarse particles. The preparatory mixing device used is generally a device which does not involve dynamic crushing, such as an agitating blade, a stirrer, a disperser, or the like.

Furthermore, after the dispersion step of the pigment has been completed, it is possible to adjust the dispersion to a desired pigment density by adding solvent, or conversely, removing solvent, according to requirements. Moreover, as and when necessary, it is also possible to remove large and coarse particles by centrifugal separation, filtering, or the like.

### Ultra-High-Pressure Homogenizer

Use of a high-pressure homogenizer can be envisaged as a method for achieving a very fine dispersion of the pigment without using beads. Examples of a high-pressure homogenizer include: a chamber type high-pressure homogenizer having a chamber to which a flow channel of treatment liquid is fixed; and a homogenizing valve type high-pressure homogenizer having a homogenizing valve. Of these, the homogenizing valve type high-pressure homogenizer allows the width of the flow channel for treatment liquid to be adjusted easily, and therefore the pressure and flow rate during operation can be set as desired, and since it has a wide range of operation, it is used commonly in the field of emulsification, such as the field of food products and the field of cosmetic products, in particular. On the other hand, a chamber type high-pressure homogenizer is used for applications which require a very high pressure, since it makes it easier to create a mechanism which raises the pressure although it allows relatively little freedom of operation.

The chamber type high-pressure homogenizer may be a micro fluidizer (made by Microfluidics Co.), a nanomizer (made by Yoshida Kikai Co., Ltd.), an Ultimaizer (made by Sugino Machine Limited), or the like.

Examples of a homogenizing valve type of high-pressure homogenizer may include: a Gaulin homogenizer (made by APV Co. Ltd.), a Rannie type homogenizer (made by Rannier), a high-pressure homogenizer (made by Niro Soavi S.p.A.), a homogenizer (made by Sanwa Machine Co. Inc.), a high-pressure homogenizer (made by Izumi Food Machinery Co. Ltd.), an ultra high-pressure homogenizer (made by Ika Co. Ltd.), and the like.

Dispersion by means of a high-pressure homogenizer is performed by the large shearing force generated when a liquid is passed through an extremely narrow (small) gap at high speed. The magnitude of this shearing force is approximately proportional to the pressure, and the greater the pressure, the stronger the shearing force, in other words, the stronger the dispersion force acting on the particles dispersed in the liquid. However, most of the kinetic energy of the liquid flowing at high speed is converted into heat, and therefore, the higher the pressure, the greater the temperature rise in the liquid, which promotes deterioration of the dispersion liquid component and re-agglutination of the particles. Consequently, there is an optimum point for the pressure of the high-pressure homogenizer, and this optimum point is considered to differ with the material to be dispersed and the target particle size. As a result of investigation, it has became clear that, in order to achieve a very fine dispersion of an organic pigment for inkjet printing according to the present invention, such that the average Stokes diameter is in the range of 30 nm to 100 nm, a high pressure of 150 MPa or above is required.

In the case of a homogenizing valve type high-pressure homogenizer, it is fairly difficult in structural terms to achieve a pressure of 150 MPa. Although it is possible to obtain pressures up to approximately 200 MPa on a test laboratory scale, when stable manufacturing conditions are taken into account, it is only possible to operate at pressures of 150 MPa or below with current technology. In contrast to this, with a chamber type high-pressure homogenizer, very high pressures up to 300 MPa can be achieved on a production scale, and therefore this type of apparatus is suitable as the pigment dispersion apparatus according to the present invention. Desirably, the operating pressure lies between 150 MPa and 300 MPa, and a pressure between 180 MPa and 280 MPa is especially desirable. Furthermore, desirably, the dispersion liquid is cooled by means of a cooler of some kind, within 30 seconds of passing through the chamber, and desirably, within 3 seconds of passing through same.

### Ultrasonic Homogenizer

It is also possible to cite use of an ultrasonic homogenizer as another good method of dispersing a pigment very finely, without using beads. More specifically, a method is known in which ultrasonic waves are radiated at a frequency of 15 to 40 kHz onto a preparatory mixture of the kind described above. However, as yet, there is no commercially available apparatus for generating ultrasonic waves that is capable of radiating ultrasonic waves on a sufficiently large scale, and therefore, this method is limited to volumes of liquid medium that can be processed, especially in a small apparatus. Consequently, although a method of manufacturing an aqueous pigment ink for inkjet recording by using an apparatus generating ultrasonic waves is good in terms of the properties of the ink manufactured thereby, the volume of ink that can be processed is small, and therefore industrial-scale production has been difficult.

In recent years, progress has been made in increasing the output of ultrasonic wave irradiation apparatuses, and some level of mass production has become possible. Examples of a high-output ultrasonic wave homogenizer include: the ultrasonic homogenizers US-1200T, RUS-1200T and MUS-1200T (all manufactured by Nihonseiki Kaisha Ltd.), and the ultrasonic processors UIP2000, UIP-4000, UIP-8000 and UIP-16000 (all manufactured by Hielscher GmbH), and the like. Very fine dispersion is possible by using a high-output ultrasonic wave irradiation apparatus of this kind at a frequency of 25 kHz or lower, and desirably, a frequency of 15 to 20 kHz, and an energy density in the dispersion unit of 100 W/cm² or above, and desirably, 120 W/cm².

If the output is set to the ranges given above, then the efficiency of the cavitation is improved, and consequently, the pigment dispersion efficiency rises, which means that large coarse particles can be broken up at the same time as achieving a very fine dispersion. Consequently, the color saturation and density of the printed image obtained from the actual aqueous pigment dispersion is improved. Furthermore, if an aqueous ink for inkjet recording is prepared from this aqueous pigment dispersion, then smooth ejection is possible and there is no degradation of product quality due to settling of the particles, or the like. Furthermore, it was also found that there is little erosion of the ultrasonic wave generating rods, which is highly beneficial as it enables the maintenance costs of the apparatus to be reduced, and so on.

A batch method is possible with ultrasonic wave irradiation, but in this case, it is desirable to use, additionally, a device for agitating the whole dispersion liquid. The agitation device used in this way may be an agitator, a magnetic stirrer, a disperser, or the like. It is more desirable that ultrasonic wave irradiation should be carried out by a flow method. In a flow method, a dispersion liquid supply tank and a supply pump are provided, and the dispersion liquid is supplied to a chamber fitted with an ultrasonic wave irradiation unit, at a uniform flow rate. Beneficial effects are obtained whatever the direction of supply of the liquid to the chamber, but particularly desirable is a method which supplies a flow of liquid in a direction whereby it collides perpendicularly with the ultrasonic wave irradiation plane.

There are no particular restrictions on ultrasonic wave irradiation time, but in practice, it is desirable that the time during which the irradiation of ultrasonic waves is performed in the vessel should be 2 to 200 minutes per kg (of aqueous pigment dispersion). If the time is too short, then dispersion will be insufficient, and if the time is too long, then there is a possibility that re-agglutination may occur. The optimum time varies with the pigment, but generally, a time of 10 minutes to 100 minutes is desirable.

There is a possibility that deterioration of the compositional components in the dispersion liquid and re-agglutination of the particles may occur as a result of increase in the temperature of the dispersion liquid due to the irradiation of ultrasonic waves having high energy density, and therefore it is desirable to combine the use of a cooling device. In the case of batch irradiation, it is possible to cool the irradiation container from the exterior or to dispose a cooling unit inside the container. Furthermore, in the case of a flow method, it is also desirable not only to cool the ultrasonic wave irradiation chamber from the exterior, but also to dispose a cooling device, such as a heat exchanger, at an intermediate point of the flow cycle.

Even more desirable dispersion is achieved if an ultrasonic wave homogenizer is used in combination with each of the ultra high-pressure homogenizer described above. In other words, by carrying out dispersion using an ultra high-pressure homogenizer after completing ultrasonic irradiation onto the preparatory mixture, it is possible to raise the efficiency of the dispersion by the ultra high-pressure homogenizer, thus reducing the number of passes required and preparing an ink of very high quality because of the reduction of the number of large coarse particles. Moreover, by radiating ultrasonic waves onto an aqueous pigment dispersion which has been dispersed by an ultra high-pressure homogenizer, large coarse particles are eliminated, and subsequent centrifugal separation or filtering operations can be omitted. Moreover, it is also possible to repeat the steps of ultra high-pressure dispersion and ultrasonic wave irradiation alternately, or in another desired sequence.

### Adaptation to Various Inkjet Systems

It is well known that if an aqueous pigment dispersion is to be used in an aqueous pigment ink for inkjet recording, then the composition and the dispersion medium, and properties such as the viscosity, surface tension and specific gravity, are required to be controlled in accordance with the inkjet ejection system used. Inkjet printers can be divided broadly into two types: continuous ejection printers and on-demand printers. Continuous ejection printers may be based on an electric field control system, or an electric charge control system, or the like. On the other hand, systems proposed for on-demand printers include: a piezoelectric method, a thermal method, an electrical discharge method, an electrostatic method, and the like, but currently, the most common methods are a laminated piezo method, which is one type of piezoelectric method, and a resistance heating method, which is one type of thermal method. The aqueous pigment dispersion according to the present invention may be used in either a continuous ejection printer ink or an on-demand printer ink, and it shows particularly marked beneficial effects when used in a thermal inkjet method.

In the case of a thermal inkjet method, problems frequently arise when ink that has relatively instable dispersion of the pigment is used. This is because the thermal history created by the thermal method itself promotes aggregation of the pigment, and there is a possibility that aggregation of the pigment and major changes in viscosity and other properties may arise as a result of evaporation of the water content and the solvent which has relatively high volatility. The block polymer according to the present invention is extremely valuable in serving to stabilize the pigment in a thermal inkjet method. However, although the ejection stability is ensured by the block polymer, it is evident that the fastness of the image after printing is particularly unsatisfactory in the case of a thermal method. As a result of analysis into the factors behind this, it was found that, if metal of Fe, Ni, Cr or Zr is present in greater concentration than 100 ppm with respect to the pigment and this metal is heated in the vicinity of the heating body, it causes detrimental effects on the fastness of the pigment after printing. Consequently, the composition according to the present invention is required in order to satisfy both the requirements of ejection stability and image fastness.

### Practical Examples

The present invention is described in more detailed below with reference to practical examples. In the following description, unless specified otherwise, indications referring to “parts” or “%” are based on mass.

### Manufacture of Magenta Pigment Dispersion A

An ABC type block polymer comprising methacrylic acid (A)/benzyl methacrylate (B)/ethoxy triethylene glycol methacrylate (C) (A:B:C=13:4:10 (mol ratio), number average molecular weight=3,000) was prepared as a polymer dispersant. Thereupon, 10 g of the polymer was mixed with 3 g of 45% aqueous solution of potassium hydroxide and 87 g of deionized water, making a total of 100 g, and this mixture was neutralized until a uniform 10% polymer solution was obtained. Next, 50 g of C.I. Pigment Red-122 and 183 g of deionized water were added to the whole amount of this polymer solution and mixed, and then agitated for 0.5 hour in a disperser machine, thereby yielding a preparatory mixture. Subsequently, this preparatory mixture was mixed with 600 g of zirconia beads having a diameter of 0.1 mm (YTZ balls, manufactured by Nikkato Corp., Japan), introduced into a 0.25-gallon dispersion vessel, and then dispersed for 8 hours using a batch type sand grinder mill (made by Imex Co., Ltd.), at an operating speed of 1500 rpm. The dispersed solution of pigment thus obtained was taken as pigment dispersion solution a. This pigment dispersion solution a had a pigment density of 15%, and the average Stokes diameter of the pigment particles as measured with a dynamic light scattering particle size measurement device (Microtrac UPA) was 70 nm.

### Manufacture of Magenta Pigment Dispersion B

An ABC type block polymer comprising methacrylic acid (A)/benzyl methacrylate (B)/ethoxy triethylene glycol methacrylate (C) (A:B:C=13:4:10 (mol ratio), number average molecular weight=3,000) was prepared as a polymer dispersant. Thereupon, 30 g of the polymer was mixed with 9 g of 45% aqueous solution of potassium hydroxide and 261 g of deionized water, making a total of 300 g, and this mixture was neutralized until a uniform 10% polymer solution was obtained. Next, 150 g of C.I. Pigment Red-122 and 550 g of deionized water were added to the whole amount of this polymer solution and mixed, and then agitated for 0.5 hour in a disperser machine, thereby yielding a preparatory mixture. Thereupon, the preparatory mixture was subjected to dispersion, for ten passes, at a pressure of 245 MPa, using an Ultimaizer HJP-25003 (made by Sugino Machine Limited). The dispersed solution of pigment thus obtained was taken as pigment dispersion solution b. This pigment dispersion solution b had a pigment density of 15%, and the average Stokes diameter of the pigment particles as measured with a dynamic light scattering particle size measurement device (Microtrac UPA) was 65 nm.

### Manufacture of Magenta Pigment Dispersion C

An ABC type block polymer comprising methacrylic acid (A)/benzyl methacrylate (B)/ethoxy tri ethylene glycol methacrylate (C) (A:B:C=13:4:10 (mol ratio), number average molecular weight=3,000) was prepared as a polymer dispersant. Thereupon, 30 g of the polymer was mixed with 9 g of 45% aqueous solution of potassium hydroxide and 261 g of deionized water, making a total of 300 g, and this mixture was neutralized until a uniform 10% polymer solution was obtained. Next, 150 g of C.I. Pigment Red-122, 15 g of sodium oleate and 535 g of deionized water were added to the whole amount of this polymer solution and mixed, and then agitated for 0.5 hour in a disperser machine, thereby yielding a preparatory mixture. Thereupon, the preparatory mixture was subjected to dispersion, for ten passes, at a pressure of 245 MPa, using an Ultimaizer HJP-25003 (made by Sugino Machine Limited). The dispersed solution of pigment thus obtained was taken as pigment dispersion solution c. This pigment dispersion solution c had a pigment density of 15%, and the average Stokes diameter of the pigment particles as measured with a dynamic light scattering particle size measurement device (Microtrac UPA) was 51 nm.

### Manufacture of Magenta Pigment Dispersion D

An ABC type block polymer comprising methacrylic acid (A)/benzyl methacrylate (B)/ethoxy triethylene glycol methacrylate (C) (A:B:C=13:4:10 (mol ratio), number average molecular weight=3,000) was prepared as a polymer dispersant. Thereupon, 30 g of the polymer was mixed with 9 g of 45% aqueous solution of potassium hydroxide and 261 g of deionized water, making a total of 300 g, and this mixture was neutralized until a uniform 10% polymer solution was obtained. Next, 150 g of C.I. Pigment Red-122 and 550 g of deionized water were added to the whole amount of this polymer solution and mixed, and then agitated for 0.5 hour in a disperser machine, thereby yielding a preparatory mixture. Next, this preparatory mixture was introduced into a dual tank with an internal capacity of 2 liters, and while the mixture was agitated with a disperser blade and cooled by means of cooled water at 18° C., the mixture was subjected to batch irradiation for 30 minutes using an ultrasonic homogenizer US-1200T (made by Nihonseiki Kaisha Ltd.) with a 36 mm-diameter tip. In this operation, the amplitude of vibration was 28 μm and the energy density of the ultrasonic wave irradiation was 110 W/cm². The dispersed solution of pigment thus obtained was taken as pigment dispersion solution d. This pigment dispersion solution d had a pigment density of 15%, and the average Stokes diameter of the pigment particles as measured with a dynamic light scattering particle size measurement device (Microtrac UPA) was 69 nm.

### Manufacture of Magenta Pigment Dispersion E

An ABC type block polymer comprising methacrylic acid (A)/benzyl methacrylate (B)/ethoxy triethylene glycol methacrylate (C) (A:B:C=13:4:10 (mol ratio), number average molecular weight=3,000) was prepared as a polymer dispersant. Thereupon, 30 g of the polymer was mixed with 9 g of 45% aqueous solution of potassium hydroxide and 261 g of deionized water, making a total of 300 g, and this mixture was neutralized until a uniform 10% polymer solution was obtained. Next, 150 g of C.I. Pigment Red-122 and 550 g of deionized water were added to the whole amount of this polymer solution and mixed, and then agitated for 0.5 hour in a disperser machine, thereby yielding a preparatory mixture. Next, this preparatory mixture was introduced into a dual tank with an internal capacity of 2 liters, and while the mixture was agitated with a disperser blade and cooled by means of cooled water at 18° C., the mixture was subjected to batch irradiation for 10 minutes using an ultrasonic homogenizer US-1200T (made by Nihonseiki Kaisha Ltd.) with a 36 mm-diameter tip. In this operation, the amplitude of vibration was 28 μm and the energy density of the ultrasonic wave irradiation was 110 W/cm². After undergoing ultrasonic dispersion, the dispersion solution was then subjected to dispersion, for five passes, at a pressure of 245 MPa, using an Ultimaizer HJP-25003 (made by Sugino Machine Limited). The dispersed solution of pigment thus obtained was taken as pigment dispersion solution e. This pigment dispersion solution e had a pigment density of 15%, and the average Stokes diameter of the pigment particles as measured with a dynamic light scattering particle size measurement device (Microtrac UPA) was 53 nm.

### Manufacture of Magenta Pigment Dispersion F

An ABC type block polymer comprising methacrylic acid (A)/benzyl methacrylate (B)/ethoxy triethylene glycol methacrylate (C) (A:B:C=13:4:10 (mol ratio), number average molecular weight=3,000) was prepared as a polymer dispersant. Thereupon, 30 g of the polymer was mixed with 9 g of 45% aqueous solution of potassium hydroxide and 261 g of deionized water, making a total of 300 g, and this mixture was neutralized until a uniform 10% polymer solution was obtained. Next, 150 g of C.I. Pigment Red-122 and 550 g of deionized water were added to the whole amount of this polymer solution and mixed, and then agitated for 0.5 hour in a disperser machine, thereby yielding a preparatory mixture. Thereupon, the preparatory mixture was subjected to dispersion, for two passes, at a pressure of 245 MPa, using an Ultimaizer HJP-25003 (made by Sugino Machine Limited). The dispersed solution of pigment thus obtained was taken as pigment dispersion solution f. This pigment dispersion solution f had a pigment density of 15%, and the average Stokes diameter of the pigment particles as measured with a dynamic light scattering particle size measurement device (Microtrac UPA) was 110 nm.

### Manufacture of Magenta Pigment Dispersion G

An ABC type block polymer comprising methacrylic acid (A)/benzyl methacrylate (B)/ethoxy triethylene glycol methacrylate (C) (A:B:C=13:4:10 (mol ratio), number average molecular weight=3,000) was prepared as a polymer dispersant. Thereupon, 30 g of the polymer was mixed with 9 g of 45% aqueous solution of potassium hydroxide and 261 g of deionized water, making a total of 300 g, and this mixture was neutralized until a uniform 10% polymer solution was obtained. Next, 150 g of C.I. Pigment Red-122 and 550 g of deionized water were added to the whole amount of this polymer solution and mixed, and then agitated for 0.5 hour in a disperser machine, thereby yielding a preparatory mixture. Thereupon, the preparatory mixture was subjected to dispersion, for four passes, at a pressure of 245 MPa, using an Ultimaizer HJP-25003 (made by Sugino Machine Limited). The dispersed solution of pigment thus obtained was taken as pigment dispersion solution g. This pigment dispersion solution g had a pigment density of 15%, and the average Stokes diameter of the pigment particles as measured with a dynamic light scattering particle size measurement device (Microtrac UPA) was 90 nm.

### Manufacture of Magenta Pigment Dispersion H

150 g of C.I. Pigment Red-122, 15 g of sodium oleate and 835 g of deionized water were added and mixed, and then agitated for 0.5 hour in a disperser machine, thereby yielding a preparatory mixture. Thereupon, the preparatory mixture was subjected to dispersion, for ten passes, at a pressure of 245 MPa, using an Ultimaizer HJP-25003 (made by Sugino Machine Limited). The dispersed solution of pigment thus obtained was taken as pigment dispersion solution h. This pigment dispersion solution h had a pigment density of 15%, and the average Stokes diameter of the pigment particles as measured with a dynamic light scattering particle size measurement device (Microtrac UPA) was 85 nm.

### Manufacture of Magenta Pigment Dispersion I

An ABC type block polymer comprising methacrylic acid (A)/benzyl methacrylate (B)/ethoxy triethylene glycol methacrylate (C) (A:B:C=13:4:10 (mol ratio), number average molecular weight=3,000) was prepared as a polymer dispersant. Thereupon, 10 g of the polymer was mixed with 3 g of 45% aqueous solution of potassium hydroxide and 87 g of deionized water, making a total of 100 g, and this mixture was neutralized until a uniform 10% polymer solution was obtained. Next, 50 g of C.I. Pigment Red-122 and 183 g of deionized water were added to the whole amount of this polymer solution and mixed, and then agitated for 0.5 hour in a disperser machine, thereby yielding a preparatory mixture. Subsequently, this preparatory mixture was mixed with 600 g of zirconia beads having a diameter of 0.1 mm (YTZ balls, manufactured by Nikkato Corp.), introduced into a 0.25-gallon dispersion vessel, and then dispersed for 10 hours using a batch type sand grinder mill (made by Imex Co., Ltd.), at an operating speed of 1200 rpm. The dispersed solution of pigment thus obtained was taken as pigment dispersion solution i. This pigment dispersion solution i had a pigment density of 15%, and the average Stokes diameter of the pigment particles as measured with a dynamic light scattering particle size measurement device (Microtrac UPA) was 68 nm.

### Manufacture of Magenta Pigment Dispersion J

An ABC type block polymer comprising methacrylic acid (A)/benzyl methacrylate (B)/ethoxy triethylene glycol methacrylate (C) (A:B:C=13:4:10 (mol ratio), number average molecular weight=3,000) was prepared as a polymer dispersant. Thereupon, 10 g of the polymer was mixed with 3 g of 45% aqueous solution of potassium hydroxide and 87 g of deionized water, making a total of 100 g, and this mixture was neutralized until a uniform 10% polymer solution was obtained. Next, 50 g of C.I. Pigment Red-122 and 183 g of deionized water were added to the whole amount of this polymer solution and mixed, and then agitated for 0.5 hour in a disperser machine, thereby yielding a preparatory mixture. Subsequently, this preparatory mixture was mixed with 600 g of zirconia beads having a diameter of 0.1 mm (YTZ balls, manufactured by Nikkato Corp.), introduced into a 0.25-gallon dispersion vessel, and then dispersed for 15 hours using a batch type sand grinder mill (made by Imex Co., Ltd.), at an operating speed of 1000 rpm. The dispersed solution of pigment thus obtained is taken as pigment dispersion solution j. This pigment dispersion solution j had a pigment density of 15%, and the average Stokes diameter of the pigment particles as measured with a dynamic light scattering particle size measurement device (Microtrac UPA) was 68 nm.

### Preparation of Magenta Inks

10 g each of the pigment dispersions a to j was taken and the following compounds were weighed, mixed and agitated with each of the pigment dispersions to yield magenta inks a to j.
glycerine: 5.0 g
diethylene glycol: 10.0 g
Olefin E1010 (made by Nissin Chemical Industry Co., Ltd.): 1.0 g
deionized water (ion exchange water): 10.0 g

The inks thus obtained were respectively filtered through an acetyl cellulose membrane filter having an average hole size of 0.5 μm (made by FUJIFILM Corporation), thereby removing large coarse particles. The pigment density of these magenta inks was 4.2%.

### Measurement of Quantity of Metal in Ink

The quantity of metal in the ink was measured by using an inductively coupled plasma spectrometer ICPS-8100 (made by Shimadzu Corporation). The detection limit was 1 ppm or less for each of the elements.

### Image Evaluation

Each of the inks a to h prepared as described above was loaded into the head of an inkjet color printer BJF-850 (made by Canon Inc.) having an on-demand type of recording head, and corresponding images were printed. The resulting image density, image saturation and light resistance were tested. A glossy photo film HG-201 (made by Canon Inc.) was used as the recording medium and a full solid image was printed. In this case, the ink was ejected at a rate of 7 g/m². The magenta image density and the yellow image density in the printed objects thus obtained were measured with an X-Rite apparatus (made by X-Rite, Incorporated). The magenta saturation was expressed simply as the ratio between the yellow density (DY) and the magenta density (DM), in other words, DY/DM. The smaller this value, the higher the magenta saturation. After carrying out density measurement, the print samples were then irradiated with a light quantity of 100,000 lux from a xenon lamp under temperature and humidity conditions of 25° C. 50% RH, using a xenon weather resistance testing device Ci-5000 (made by Atlas Material Testing Technology LLC.). The magenta density (OD) was measured with the X-Rite apparatus every 7 days, and irradiation was continued for 42 days. The residual OD was determined from these measurement values.

### Ink Storage Characteristics

The inks a to h prepared as described above were input respectively into sealed vessels whose material was the same as that of the cartridges, and were left for one week at 70° C. and frozen and left for one week. Subsequently, the inks were returned to room temperature, agitated well, and then the size of the pigment particles was measured with the dynamic light scattering particle size measurement device and the measured size was compared with the particle size immediately after preparation of the ink. The following ranks were assigned to the inks according to the change in the median particle size: rank A: change of less than 5%; rank B: change equal to or greater than 5% and less than 10%; rank C: change equal to or greater than 10% and less than 30%; rank D: change equal to or greater than 30% and less than 100%; and rank E: change of 100% or greater.

The results of the above-described evaluation are shown in a table in the single accompanying drawing. It was found that all of the ink samples according to the present invention had good print density, saturation (better saturation, the lower the color clouding), light resistance and ink storage stability. On the other hand, in sample “a” which was given as a comparative example, due to the high metallic content, the light-fastness was markedly inferior. Furthermore, of the samples a, i and j, which have a high metal content, the sample j had a metal content equal to or less than 100 ppm, and therefore had good ink storage stability. In the case of comparative example f which had a large dispersed particle size, the print density was low and color clouding was high. Furthermore, the storage characteristics of the ink were poor. In comparative example h which does not use the block polymer according to the present invention, there was a clear and marked deterioration in the storage characteristics of the ink. Therefore, from these results, it can be seen that the composition according to the present invention is essential in order to achieve both good print quality including light fastness, and good ink storage characteristics.

Furthermore, as the sample c of the present invention reveals, additional use of a low-molecular-weight anionic surfactant is valuable in raising print quality. Moreover, as the sample e according to the present invention reveals, a method of manufacture which uses a combination of dispersion in an ultrasonic homogenizer and dispersion in an ultra high-pressure homogenizer is useful in raising print quality, in addition to increasing the efficiency of the dispersion process.

As described above, in embodiments of the present invention, beneficial effects brought about by pigment having a relatively small particle size or beneficial effects brought about by a block polymer can be obtained.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An aqueous pigment ink composition comprising:
a pigment; and
a block polymer containing at least one type of hydrophilic block and at least one type of hydrophobic block, wherein:
an average Stokes diameter of dispersed particles including the pigment and the block polymer is in a range of 30 nm to 100 nm; and
a total content of metal in the aqueous pigment ink composition is not more than 100 ppm with respect to the pigment.

2. The aqueous pigment ink composition as defined in claim 1, wherein the metal includes at least one of Fe, Ni, Cr and Zr.

3. The aqueous pigment ink composition as defined in claim 1, wherein the average Stokes diameter of the dispersed particles is 40 nm to 80 nm.

4. The aqueous pigment ink composition as defined in claim 1, wherein the total content of the metal is not more than 20 ppm with respect to the pigment.

5. The aqueous pigment ink composition as defined in claim 1, further comprising an anionic surfactant.

6. The aqueous pigment ink composition as defined in claim 5, wherein a number average molecular weight of the anionic surfactant is 100 to 2000.

7. The aqueous pigment ink composition as defined in claim 1, wherein the block polymer has a polyalkenyl ether structure.

8. The aqueous pigment ink composition as defined in claim 7, wherein the block polymer has a repeated unit of a vinyl ether polymer structure having an oxyethylene side chain as expressed by the following general formula:
—(CH₂—CH(OR¹))—,
where R¹ is a group represented by —(CH₂—CH₂—O)ₖ—R²,—(CH₂)ₘ—(O)ₙ—R²,—R³—X, —(CH₂—CH₂—O)ₖ—R₃—X, or —CH₂)ₘ—(O)ₙ—X; R² represents a hydrogen atom, a straight-chain or branched alkyl group having 1 to 4 carbon atoms, or —CO—CH═CH₂,—CO—C(CH₃)═CH₂,—CH₂—CH═CH₂, or —CH₂—C(CH₃)═CH₂; R³ represents an aliphatic hydrocarbon group or an aromatic hydrocarbon group; and X represents a group that has anionic properties and is selected from a carboxylic acid group, a sulfonic acid group, and a phosphoric acid group.

9. The aqueous pigment ink composition as defined in claim 1, wherein the pigment included in the dispersed particles is dispersed by an ultra high-pressure homogenizer, at a pressure of not less than 150 MPa.

10. The aqueous pigment ink composition as defined in claim 1, wherein the pigment included in the dispersed particles is dispersed by an ultrasonic homogenizer, at a frequency of not more than 25 kHz and an energy density in a dispersion unit of not less than 100 W/cm².

11. The aqueous pigment ink composition as defined in claim 1, wherein the pigment included in the dispersed particles is dispersed by an ultrasonic homogenizer, at a frequency of not more than 25 kHz and an energy density in a dispersion unit of not less than 100 W/cm², and then dispersed by an ultra high-pressure homogenizer, at a pressure of not less than 150 MPa.

12. The aqueous pigment ink composition as defined in claim 1, wherein the pigment included in the dispersed particles is dispersed by an ultra high-pressure homogenizer, at a pressure of not less than 150 MPa, and then dispersed ultrasonically by an ultrasonic homogenizer, at a frequency of not more than 25 kHz and an energy density in a dispersion unit of not less than 100 W/cm².

13. An inkjet ink containing the aqueous pigment ink composition as defined in claim 1.

14. The inkjet ink as defined in claim 13, wherein the inkjet ink is for use in a thermal inkjet system.

15. An inkjet ink set comprising three color inks of cyan ink, magenta ink and yellow ink, wherein at least one color ink of the three color inks is the inkjet ink as defined in claim 13.
